(19) United States
(12) Patent Application Publication
(10) Pub. No.: US 2026/0200372 A1
(43) Pub. Date: Jul. 16, 2026

(54) ADJUSTABLE SEAT FOR LOW ROOFLINE VEHICLE

(71) Applicant: FCA US LLC, Auburn Hills, MI (US)

(72) Inventors: Brandon F. Brady, Auburn Hills, MI (US); Travis D. Bechtel, Auburn Hills, MI (US); Zachary A. Luetzen, Auburn Hills, MI (US)

(21) Appl. No.: 19/017,884

(22) Filed: Jan. 13, 2025

(51) Int. Cl. B60N 2/12; B60N 2/075; B60N 2/90

(52) U.S. Cl. CPC B60N 2/12; B60N 2/075; B60N 2/929

(57) ABSTRACT

A slouch seat suited for use in a low block height and low roofline vehicle, wherein the slouch seat includes a seat pan; a seat back; and a pair of support assemblies configured to permit fore and aft movement of the slouch seat, pivoting of the seat back and seat pan relative to the support assemblies from a non-slouched position to a slouched position, and pivoting of the seat pan relative to seat back. The slouch seat provides improved comfort and accommodation of various drive body dimensions.

### FIELD

The present disclosure relates to an adjustable seat for a low roofline vehicle.

### BACKGROUND

This section provides background information related to the present disclosure which is not necessarily prior art.

Racing vehicles typically have low roofline to help lower the vehicle's center of gravity and improve aerodynamics, accompanied by a driver's seat that is rigid and immovable, and has dimensions and orientations that are specific to a driver of the vehicle. In some races, however, the vehicle may be operated by more than one driver, which typically requires a changeover scenario where the seat is removed and replaced with another seat that has dimensions and orientations that are specific to that driver. It is desirable, therefore, for a seat that can be used in a racing vehicle that can move in various directions to accommodate different drivers without sacrificing comfort of the drivers of the vehicle.

### SUMMARY

This section provides a general summary of the disclosure, and is not a comprehensive disclosure of its full scope or all of its features.

According to an aspect of the present disclosure, there is provided a slouch seat for use in a vehicle that includes a seat pan; a seat back; and a pair of support assemblies configured to permit fore and aft movement of the slouch seat, pivoting of the seat back and seat pan relative to the support assemblies from a non-slouched position to a slouched position, and pivoting of the seat pan relative to seat back, wherein the support assemblies each include a fixed track member, a sliding track member mated with and slidable relative to the fixed track member that permits the fore and aft movement of the slouch seat, a link arm fixed to the sliding track member that is connected to each of the seat back and the seat pan that permits pivoting of the seat back and seat pan relative to the support assemblies, and pivot arms having a proximate end pivotably attached to the fixed track member and a distal end pivotably attached to the seat pan that permits the seat pan to pivot relative to the seat back.

According to the aspect, the fixed track member includes a bottom panel configured to be attached to a floor of the vehicle, first and second upwardly extending side panels attached to the bottom panel that define a first channel configured for receipt of the sliding track member, and inwardly extending flanges that each transitions to downwardly extending flanges that are attached to each of the first and second upwardly extending side panels, and each downwardly extending flange include a plurality of slots at a terminal end thereof.

According to the aspect, the sliding track member includes a top panel, first and second downwardly extending side panels attached to the top panel that define a second elongated channel configured for receipt within the first elongated channel of the fixed track member, and outwardly flanges attached to the first and second downwardly extending side panels that transition to upwardly extending flanges, and the downwardly extending flanges of the fixed track member are received within gaps that are positioned between the first and second downwardly extend side panels and the upwardly extending flanges of the sliding track member to restrict upward movement of sliding track member relative to the fixed track member.

According to the aspect, the first and second downwardly extending side panels each include a plurality of apertures that are alignable with the plurality of slots of the fixed track member, and the plurality of slots and apertures are configured for receipt of a pin of a latching mechanism of the support assemblies to fix a position of the sliding track member relative to the fixed track member in the fore and aft directions.

According to the aspect, the link arm includes a base panel fixed to the top panel of the sliding track member and a planar connection panel extending upward from the base panel, the connection panel including a shaft section and a blade section that extends angularly upward and outward relative to shaft section, the blade section defining an aperture configured for receipt of a pivot pin that permits the seat pan to pivot relative to the seat back while also permitting the seat back to pivot relative to the support assemblies.

According to the aspect, the pivot arms each include a proximate end pivotably attached to the fixed track member and a distal end pivotably attached to the seat pan.

According to the aspect, the seat pan includes elongated apertures that permits the distal end of the pivot arms to pass therethrough.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an isometric perspective view of an example slouch seat according to a principle of the present disclosure;

FIG. 2 is another isometric perspective view of the example slouch seat shown in FIG. 1;

FIG. 3 is a side-perspective view of the slouch seat illustrated in FIG. 1 in non-slouched position;

FIG. 4 is a side-perspective view of the slouch seat illustrated in FIG. 1 in a slouched position;

FIG. 5 is an isometric perspective view of a support assembly of the slouch seat illustrated in FIG. 1; and

FIG. 6 is a front-perspective view of the support assembly illustrated in FIG. 5.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

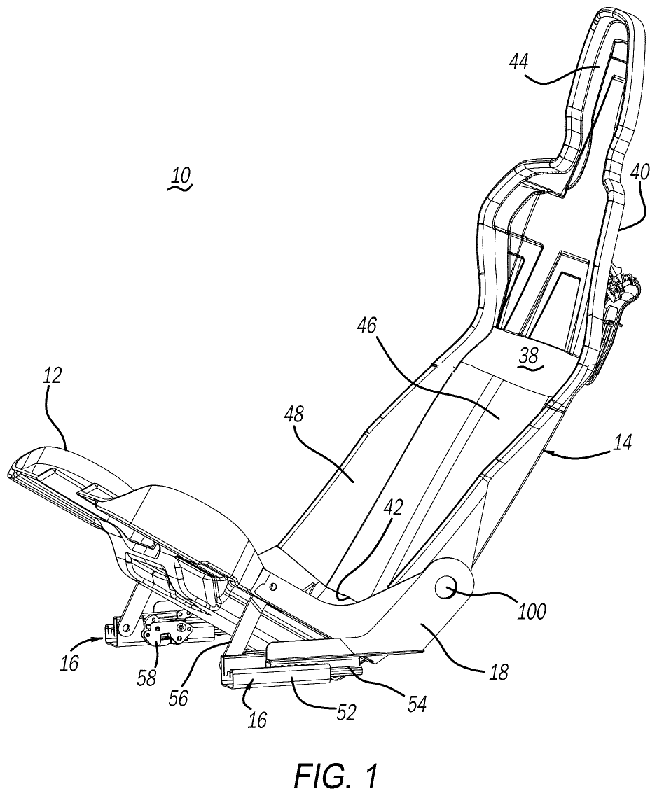

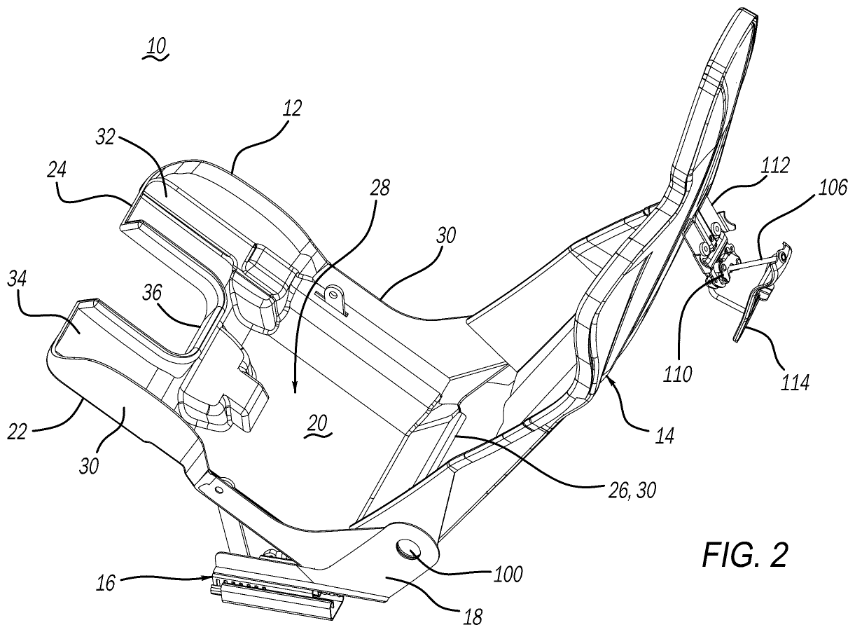

FIGS. 1-4 illustrate an adjustable seat (hereinafter “slouch seat”) 10 according to a principle of the present disclosure. Slouch seat 10 generally includes a seat pan 12 configured to support a seat cushion (not shown) and a seat back 14. Slouch seat 10 also includes a pair of support assemblies 16 having a pair of link arms 18 attached thereto that are each configured to support seat pan 12 and seat back 14. Link arms 18 are attached to supports 16, and configured to slide fore and aft in the directions of double-sided arrow 19.

Seat pan 12 may be a monolithic member formed of a rigid material such as a rigid polymeric material such as polyamide (e.g., NYLON®), polystyrene, or polyethylene, or a rigid metal material such as aluminum, steel, or any other rigid metal material known to one skilled in the art. Seat pan includes an upper surface 20 configured to support a seat cushion (not shown), an opposite lower surface 22 configured to face a floor (not shown) of a vehicle (not shown), a forward end 24, and an aft end 26 attached to seat back 14. Upper surface 20 may define a first recess 28 configured for receipt of the seat cushion (not shown) that is surrounded by first perimeter walls 30. While not required, forward end 24 may include first and second sections 32, 34 separated by a U-shaped gap 36 such that first and second sections 32 and 34 may provide support for an occupant's legs.

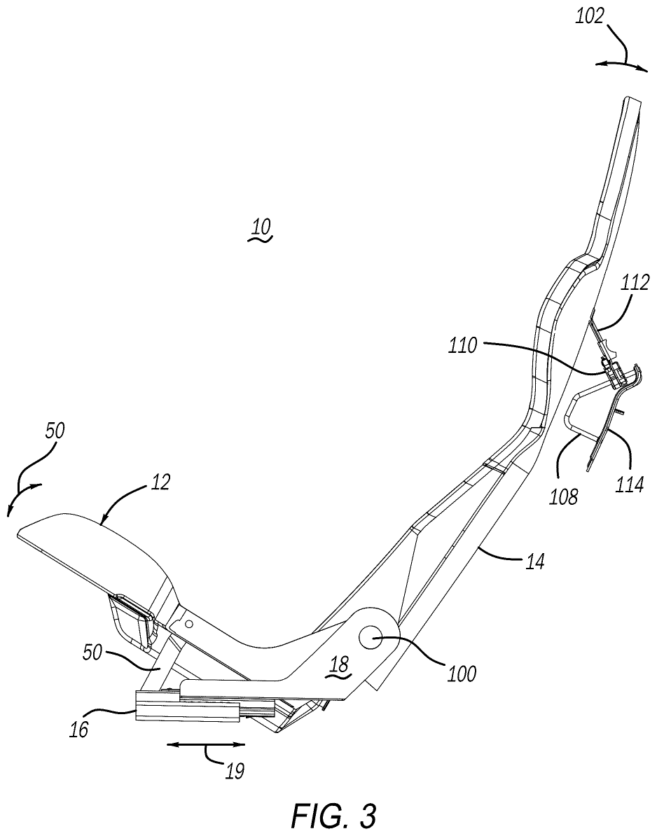

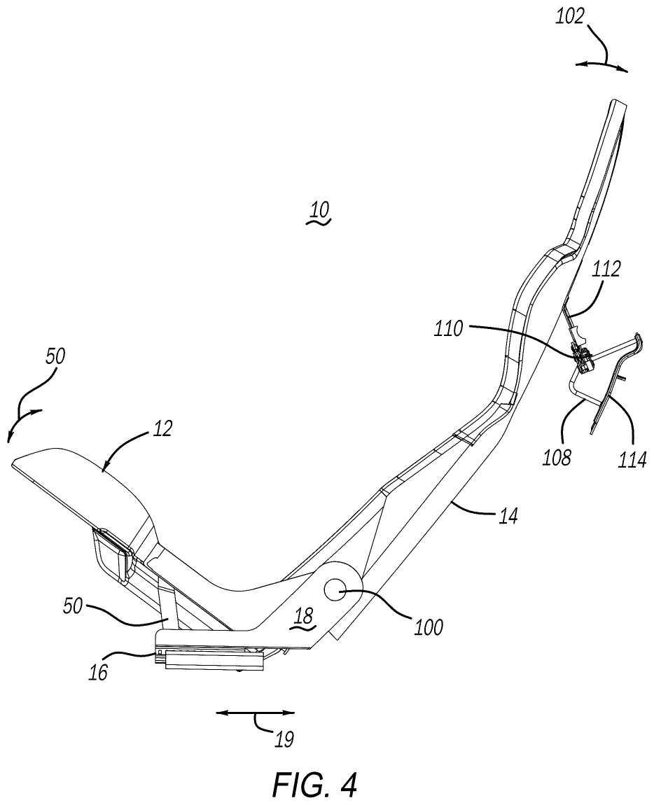

Seat back 14 may also be a monolithic member formed of the same or a material similar to that selected for seat pan 12. Seat back 14 includes a front surface 38 that is configured to face an occupant's back, a rear surface 40 that is configured to face a wall (not shown) of the vehicle (not shown), a lower end 42 configured to be attached to seat pan 12, and an upper end 44 that is configured to provide support for an occupant's head. Put another way, upper end 44 may define a head rest of slouch seat 10. Front surface 38 may define a second recess 46 configured for receipt of a seat back cushion (not shown) that is surrounded by second perimeter walls 48. Seat pan 12 is pivotable relative to seat back 14 in directions along double-sided arrow 50 (FIGS. 3 and 4), as will be described in more detail later.

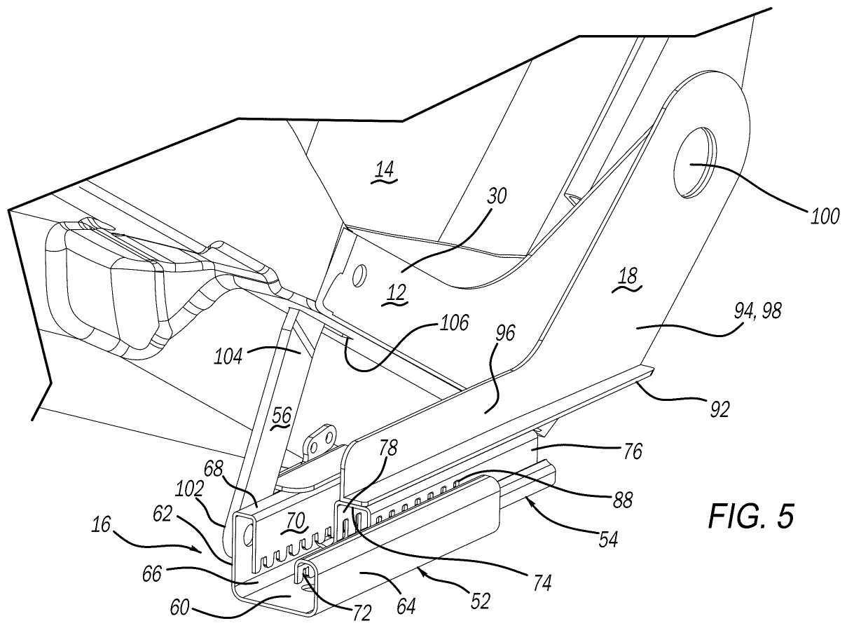

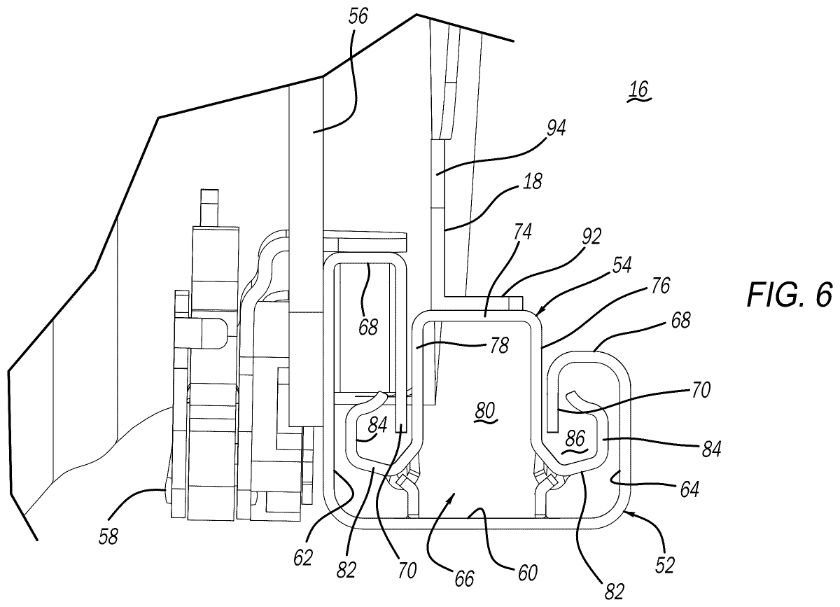

Support assemblies 16 are configured to attach slouch seat 10 to a floor (not shown) of a vehicle (not shown), and permit a position of slouch seat 10 to be moved in the fore and aft directions shown by the double-sided arrow 19. As best shown in FIGS. 5 and 6, each support assembly 16 includes a fixed track member 52, a sliding track member 54, link arm 18, a pivot arm 56, and a first latching mechanism 58.

Fixed track member 52 may be formed of a rigid metal material such as steel, aluminum, or any other type of rigid metal material known to one skilled in the art. Fixed track member 52 is an elongated member having C-shaped cross-section. More particularly, fixed track member 52 may include a bottom panel 60 configured to be fixed to the floor (not shown) of the vehicle via first latching mechanisms 58, a first upwardly extending side panel 62 unitary with the bottom panel 60, and a second upwardly extending side panel 64 unitary with the bottom panel 62, wherein the first and second upwardly extending side panels 62, 64 define a first elongated channel 66 configured for receipt of sliding track member 54. An inwardly flange 68 that transitions to a downwardly extending flange 70 may be attached to each of the first and second upwardly extending side panels 62, 64 to ensure that while sliding track member 54 may slide along first elongated channel 66, sliding track member 54 may not exit the first elongated channel 66 in an upward direction. Each downwardly extending flange 70 may include a plurality of slots 72 at a terminal end thereof, with each slot 72 defining a fore-aft position of the slouch seat 10 along the fixed track member 52. While fixed track member 52 can be attached to the floor of the vehicle using first latching mechanisms 58 so that slouch seat 10 can be quickly removable, it should be understood that fixed track members 52 can be mechanically fastened to the floor of the vehicle without departing from the scope of the present disclosure.

Sliding track member 54 is similar to fixed track member 52. In this regard, sliding track member 54 may be formed of a rigid metal material such as steel, aluminum, or any other type of rigid metal material known to one skilled in the art. Sliding track member 54 is an elongated member having C-shaped cross-section. More particularly, sliding track member 54 may include a top panel 74 configured to be fixed to the link arm 18, a first downwardly extending side panel 76 unitary with the top panel 74, and a second downwardly extending side panel 78 unitary with the top panel 74, wherein the first and second downwardly extending side panels 76, 78 define a second elongated channel 80 configured for receipt within first elongated channel 66 of fixed track member 52.

An outwardly flange 82 that transitions to an upwardly extending flange 84 may be attached to each of the first and second downwardly extending side panels 76, 78 to ensure that while sliding track member 54 may slide along first elongated channel 66, sliding track member 54 may not exit the first elongated channel 66 in an upward direction. That is, the downwardly extending flanges 70 are received within a gap 86 (FIG. 6) that is positioned between the downwardly extend side panel 76, 78 and the upwardly extending flanges 84 such that upward movement of sliding track member 54 would cause contact between the downwardly extending flanges 70 and the outwardly extending flanges 82 that restricts movement in the upward direction. Each downwardly extending side panel 76, 78 may include a plurality of apertures 88 that may align with the slots 72 of fixed track member 52 that define a fore-aft position of the slouch seat 10 along the fixed track member 52. Movement between sliding track member 54 and fixed track member 52 may be facilitated by a ball bearing (not shown) provided between inwardly extending flange 68 and upwardly extending flange 84 on a side of support 56 that is distal from first latch mechanisms 58, as is known in the art. Latching of sliding track member 54 relative to fixed track member 52 may be facilitated by a pin (not shown) that is cable (not shown) actuated, as is known in the art.

First latching mechanisms 58 are attached to first upwardly extending side panels 62 of fixed track member 52. First latching mechanisms 58 are configured to latch onto an anchor (not shown) provided in a floor of the vehicle (not shown), which permits fixed track members 52 to be fixed to the floor of the vehicle when slouch seat 10 is being used while also permitting slouch seat 10 to be quickly removed in the event of a driver change during a race.

Link arms 18 may be formed of a rigid metal material such as steel, aluminum, or any other type of rigid metal material known to one skilled in the art, and are fixed to top panels 74 of sliding track members 54 such that link arms 18 are configured to move relative to fixed track members 52 along with sliding track members 54 as a position of sliding track members 54 is adjusted. Each link arm 18 includes a base panel 92 fixed to top panel 72, and a planar connection panel 94 extending upward from base panel 92. Connection panel 94 may be generally shaped like a hockey stick including a surface 96 and a blade section 98 that extends angularly upward and outward relative to shaft section 96. Blade section 98 defines an aperture configured for receipt of a pivot pin 100 that permits seat pan 12 to pivot in directions defined by double-arrow 50 relative to seat back 14, while also permitting seat back 14 to pivot in directions defined by double-arrow 102. That is, slouch seat 10 is configured such that the combination of seat pan 12 and seat back 14 can pivot together in directions defined by double-arrow 102, and slouch seat 10 is also configured such that seat pan 12 may independently pivot in directions defined by double-arrow 50 relative to seat back 14. While not shown in the drawings, a clock spring may be used to latch the position of the slouch seat 10.

In order to permit seat pan 12 to pivot independently relative to seat back 14, it can be seen in FIGS. 1-4 that support assemblies 16 each include a pivot arm 56. Pivot arms 56 include a proximate end 102 and a distal end 104, with proximate end 102 being pivotably attached to fixed track member 52 and distal end 104 being pivotably attached to first perimeter wall 30 of seat pan 12. To connect distal end 104 of first perimeter wall 30 of seat pan 12, seat pan 12 includes an elongated through-hole 106 that permits distal end 104 pass therethrough.

FIG. 3 illustrates slouch seat 10 in a slouched position, after it has been moved from the non-slouched position shown in FIG. 4. The slouched position is evident from the position of seat back 14 relative to a hook 108 that is attached to a wall (not shown) of the vehicle (not shown). Seat back 14 may be attached to hook 108 using a second latching mechanism 110 that is attached to seat back 14 using a first bracket 112. For all intents and purposes, second latching mechanism 110 is similar to first latching mechanism 58, which permits slouch seat 10 to be disengaged from hook 108 so that slouch seat 10 can easily be removed from the vehicle as necessary. When slouch seat 10 is in the slouched position (FIG. 3), second latching mechanism 110 moves along hook 108 to a position located nearer a second bracket 114 that fixes hook 108 to the rear wall (not shown) of the vehicle (not shown). The movement from the non-slouched position (FIG. 4) to the slouched position (FIG. 3) is also evident by the position of pivot arms 56 where in FIG. 4 the pivot arms 56 are in a more upright orientation and in FIG. 3 the pivot arms 56 are angled in the aft direction toward hook 108.

When slouch seat 10 is in the slouched position (FIG. 3), seat pan 12 may be in a position relative to an occupant's legs that may be uncomfortable due to the change in orientation of the occupant. By permitting seat pan 12 to move relative to seat back 14 in directions along the double-arrow 50, a position of seat pan 12 can be adjusted to a position that can either increase or decrease the pressure on the occupant's legs. This can be particularly advantageous when the slouch seat 10 is a driver's seat of the vehicle, and the occupant is operating the vehicle for an extended period of time.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A slouch seat for use in a vehicle, the slouch seat comprising:
a seat pan;
a seat back; and
a pair of support assemblies configured to permit fore and aft movement of the slouch seat, pivoting of the seat back and seat pan relative to the support assemblies from a non-slouched position to a slouched position, and pivoting of the seat pan relative to seat back,
wherein the support assemblies each include a fixed track member, a sliding track member mated with and slidable relative to the fixed track member that permits the fore and aft movement of the slouch seat, a link arm fixed to the sliding track member that is connected to each of the seat back and the seat pan that permits pivoting of the seat back and seat pan relative to the support assemblies, and pivot arms having a proximate end pivotably attached to the fixed track member and a distal end pivotably attached to the seat pan that permits the seat pan to pivot relative to the seat back.

2. The slouch seat according to claim 1, wherein the fixed track member includes a bottom panel configured to be attached to a floor of the vehicle, first and second upwardly extending side panels attached to the bottom panel that define a first channel configured for receipt of the sliding track member, and inwardly extending flanges that each transitions to downwardly extending flanges that are attached to each of the first and second upwardly extending side panels, and
wherein each downwardly extending flange include a plurality of slots at a terminal end thereof.

3. The slouch seat according to claim 2, wherein the sliding track member includes a top panel, first and second downwardly extending side panels attached to the top panel that define a second elongated channel configured for receipt within the first elongated channel of the fixed track member, and outwardly flanges attached to the first and second downwardly extending side panels that transition to upwardly extending flanges, and
wherein the downwardly extending flanges of the fixed track member are received within gaps that are positioned between the first and second downwardly extend side panels and the upwardly extending flanges of the sliding track member to restrict upward movement of sliding track member relative to the fixed track member.

4. The slouch seat according to claim 3, wherein the first and second downwardly extending side panels each include a plurality of apertures that are alignable with the plurality of slots of the fixed track member, and
wherein the plurality of slots and apertures are configured for receipt of a pin of a latching mechanism of the support assemblies to fix a position of the sliding track member relative to the fixed track member in the fore and aft directions.

5. The slouch seat according to claim 3, wherein the link arm includes a base panel fixed to the top panel of the sliding track member and a planar connection panel extending upward from the base panel, the connection panel including a shaft section and a blade section that extends angularly upward and outward relative to shaft section, the blade section defining an aperture configured for receipt of a pivot pin that permits the seat pan to pivot relative to the seat back while also permitting the seat back to pivot relative to the support assemblies.

6. The slouch seat according to claim 2, wherein the pivot arms each include a proximate end pivotably attached to the fixed track member and a distal end pivotably attached to the seat pan.

7. The slouch seat according to claim 6, wherein the seat pan includes elongated apertures that permits the distal end of the pivot arms to pass therethrough.
